(19) United States
(12) Patent Application Publication
(10) Pub. No.: US 2025/0182939 A1
(43) Pub. Date: Jun. 5, 2025

(54) SURGE-ABSORBING ELEMENT

(71) Applicant: Panasonic Intellectual Property Management Co., Ltd., Osaka (JP)

(72) Inventors: Yoshiko HIGASHI, Osaka (JP); Eiichi KOGA, Hokkaido (JP)

(21) Appl. No.: 18/840,813

(22) PCT Filed: Feb. 22, 2023
(86) PCT No.: PCT/JP2023/006425

§ 371 Date: Aug. 22, 2024

(30) Foreign Application Priority Data
Feb. 28, 2022 (JP) 2022-030358

(51) Int. Cl. H01C 7/12; H01C 1/14

(52) U.S. Cl. CPC H01C 7/12; H01C 1/14

(57) ABSTRACT

A surge-absorbing element includes a sintered body, a pair of internal electrodes, and a pair of external electrodes. The sintered body has a pair of end surfaces facing away from each other and a plurality of side surfaces each adjacent to the pair of end surfaces. The sintered body includes a functioning part having a void and an outer shell part covering the functioning part and having a lower void ratio than the functioning part. The pair of internal electrodes face each other while the functioning part is disposed between the pair of internal electrodes. Each of the pair of external electrodes includes a first portion covering a corresponding one of the pair of end surfaces and second portions each covering a corresponding one of the plurality of side surfaces. A thickness of each of the second portions is greater than a thickness of the first portion.

### TECHNICAL FIELD

The present disclosure relates to surge-absorbing elements. Specifically, the present disclosure relates to a surge-absorbing element configured to absorb a surge current.

### BACKGROUND ART

Patent Literature 1 describes a surge-absorbing element including a first electrode and a second electrode disposed to face each other and a ceramic layer at least partially in contact with the first electrode and the second electrode. The ceramic layer has a polycrystal structure including a plurality of crystal grains showing voltage nonlinearity.

In a surge-absorbing element as described in Patent Literature 1, there is a demand for efficient dissipation of heat generated when a surge current flows.

### Citation List

### Patent Literature

Patent Literature 1: WO 2010/122732 A1

### SUMMARY OF INVENTION

In view of the foregoing, it is an object of the present disclosure to provide a surge-absorbing element with improved heat dissipation.

A surge-absorbing element according to an aspect of the present disclosure includes a sintered body, a pair of internal electrodes, and a pair of external electrodes. The sintered body has a pair of end surfaces facing away from each other and a plurality of side surfaces each adjacent to the pair of end surfaces. The pair of internal electrodes are disposed in the sintered body. The pair of external electrodes are disposed on the pair of end surfaces on a one-to-one basis and electrically connected to the pair of internal electrodes on a one-to-one basis. The sintered body includes a functioning part having a void and an outer shell part covering the functioning part and having a lower void ratio than the functioning part. The pair of internal electrodes face each other while the functioning part is disposed between the pair of internal electrodes. Each of the pair of external electrodes includes a first portion covering a corresponding one of the pair of end surfaces and second portions each covering at least part of a corresponding one of the plurality of side surfaces. A thickness of each of the second portions is smaller than a thickness of the first portion.

A surge-absorbing element according to an aspect of the present disclosure includes a sintered body, a pair of internal electrodes, and a pair of external electrodes. The sintered body has a pair of end surfaces facing away from each other and a plurality of side surfaces each adjacent to the pair of end surfaces. The pair of internal electrodes are disposed in the sintered body. The pair of external electrodes are disposed on the pair of end surfaces on a one-to-one basis and electrically connected to the pair of internal electrodes on a one-to-one basis. The sintered body includes a functioning part having a void and an outer shell part covering the functioning part and having a lower void ratio than the functioning part. The pair of internal electrodes face each other while the functioning part is disposed between the pair of internal electrodes. Each of the pair of external electrodes includes a first portion covering a corresponding one of the pair of end surfaces and second portions each covering at least part of a corresponding one of the plurality of side surfaces. The second portions each have a length from the corresponding one of the pair of end surfaces, the length of each of the second portions from the corresponding one of the pair of end surfaces being greater at a center part apart from a border between adjacent two side surfaces of the plurality of side surfaces than at the border.

### BRIEF DESCRIPTION OF DRAWINGS

FIG. 1 is a cross-sectional side view of a surge-absorbing element according to an embodiment of the present disclosure;

FIG. 2 is a cross-sectional top plan view of the surge-absorbing element;

FIG. 3 is an enlarged view of a main part of the cross-sectional side view of the surge-absorbing element;

FIG. 4 is a cross-sectional side view of a surge-absorbing element of a first variation;

FIG. 5 is a cross-sectional top plan view of the surge-absorbing element of the first variation;

FIG. 6 is a cross-sectional side view of a surge-absorbing element of a second variation;

FIG. 7 is a cross-sectional top plan view of the surge-absorbing element of the second variation;

FIG. 8 is a cross-sectional side view of a surge-absorbing element of a third variation;

FIG. 9 is a cross-sectional side view of a main part of a surge-absorbing element of a fourth variation;

FIG. 10 is a cross-sectional top plan view of the main part of the surge-absorbing element of the fourth variation;

FIG. 11 is a bottom view of a surge-absorbing element of a fifth variation; and

FIG. 12 is a cross-sectional side view of a surge-absorbing element of a sixth variation.

### DESCRIPTION OF EMBODIMENTS

With reference to the drawings, a surge-absorbing element 1 according to an embodiment of the present disclosure will be described in detail. Note that the embodiment and variations described below are merely examples of the present disclosure, and the present disclosure is not limited to the embodiment and the variations. The present disclosure may be modified variously within the scope of the technical idea of the present disclosure, even if not including the embodiment and the variations, according to design or the like. Further, the embodiment described below (including the variations) may be implemented by appropriately in combination.

### (1) Overview

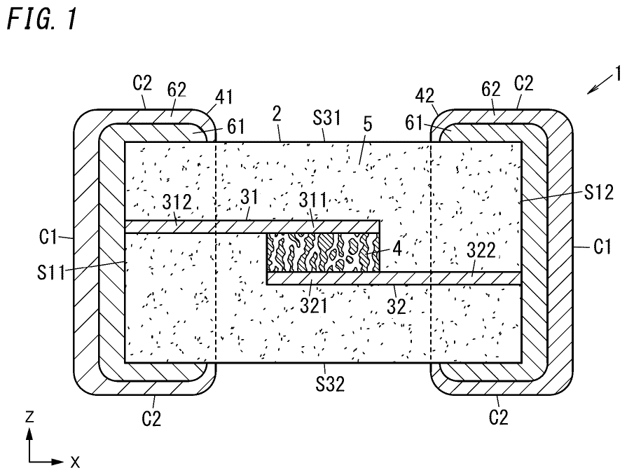

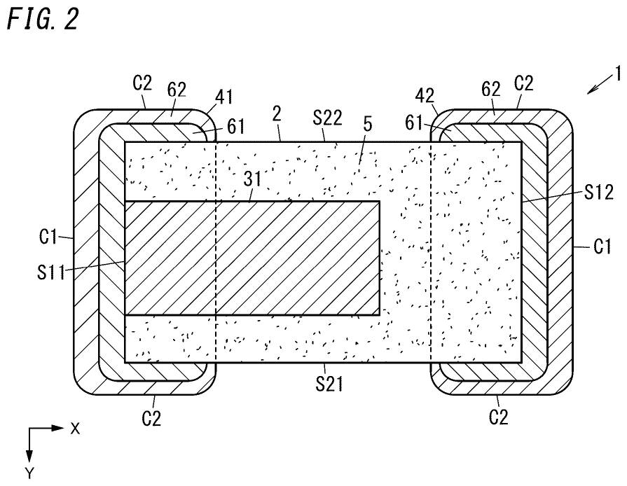

With reference to FIGS. 1 and 2, an overview of a surge-absorbing element 1 will be described below. Drawings described in the following embodiment are schematic views, and the ratios of the size and thickness of each component in the figures do not necessarily reflect actual proportion.

As shown in FIG. 1, the surge-absorbing element 1 includes a sintered body 2, a pair of internal electrodes (a first internal electrode 31 and a second internal electrode 32), and a pair of external electrodes (a first external electrodes 41 and a second external electrodes 42).

As shown in FIGS. 1 and 2, the sintered body 2 has: a pair of end surfaces (a first end surface S11 and a second end surface S12) facing away from each other; and a plurality of side surfaces (a first side surface S21, a second side surface S22, a first principal surface S31, and a second principal surface S32) each adjacent to the pair of end surfaces.

The first internal electrode 31 and the second internal electrode 32 are disposed in the sintered body 2.

The first external electrode 41 is disposed on the first end surface S11 and is electrically connected to the first internal electrode 31. The second external electrode 42 is disposed on the second end surface S12 and is electrically connected to the second internal electrode 32.

The sintered body 2 includes: a functioning part 4 having a void; and an outer shell part 5 covering the functioning part 4 and having a lower void ratio than the functioning part 4.

The first internal electrode 31 and the second internal electrode 32 face each other while the functioning part 4 is disposed between the first internal electrode 31 and the second internal electrode 32.

The first external electrode 41 includes: a first portion C1 covering the first end surface S11; and second portions C2 each covering at least part of a corresponding one of the first side surface S21, the second side surface S22, the first principal surface S31, and the second principal surface S32. The second external electrode 42 includes: a first portion C1 covering the second end surface S12; and second portions C2 each covering at least part of a corresponding one of the first side surface S21, the second side surface S22, the first principal surface S31, and the second principal surface S32.

The thickness of each of the second portions C2 is smaller than the thickness of the first portion C1.

In this embodiment, the thickness of the first portion C1 covering the first end surface S11 is the thickness of the first portion C1 along a normal direction to the first end surface S11, and the thickness of the first portion C1 covering the second end surface S12 is the thickness of the first portion C1 along a normal direction to the second end surface S12. Moreover, the thickness of each of the second portions C2 each covering at least part of a corresponding one of the first side surface S21, the second side surface S22, the first principal surface S31, and the second principal surface S32 is the thickness of the each of the second portions C2 along a normal direction to a part covered with the each of the second portions C2.

The surge-absorbing element 1 is mounted on a substrate by bonding the first external electrode 41 and the second external electrode 42 to the substrate with a bonding material such as solder. In a state where the surge-absorbing element 1 is mounted on the substrate, applying a surge voltage between the first external electrode 41 and the second external electrode 42 causes a surge current to flow, via the functioning part 4, between the first internal electrode 31 electrically connected to the first external electrode 41 and the second internal electrode 32 electrically connected to the second external electrode 42. Here, mounting the surge-absorbing element 1 on the substrate such that the second portion C2 of each of the first external electrode 41 and the second external electrode 42 is in contact with the substrate enables heat generated when a surge current flows through the functioning part 4 to efficiently be dissipated into the substrate via the second portions C2 each having a smaller thickness than the first portion C1. This can improve dissipation of heat generated when a surge current flows through the functioning part 4 of the surge-absorbing element 1.

### (2) Details

With reference to the drawings, the surge-absorbing element 1 of the present embodiment will be described in detail below.

In the present embodiment, the sintered body 2 of the surge-absorbing element 1 except for the first external electrode 41 and the second external electrode 42 is in the shape of a rectangular parallelepiped having, for example, a length of 0.6 mm, a width of 0.3 mm, and a height of 0.3 mm. Note that corners of the sintered body 2 may accordingly be beveled so that the corners of the sintered body 2 may be rounded.

In the following description, a long side direction (left/right direction) of the sintered body 2 is referred to as an “X-axis direction”, a depth direction (forward/backward direction) of the sintered body 2 is referred to as a “Y-axis direction”, and a thickness direction (up/down direction) of the sintered body 2 is referred to as a “Z-axis direction”. X-, Y-, and Z-axes defining the respective directions are orthogonal to one another. Moreover, the positive side of the X-axis direction is defined to be the right side, the positive side of the Y-axis direction is defined to be the front side, and the positive side of the Z-axis direction is defined to be the upside. However, these directions are mere examples and should not be construed as limiting the orientation that the surge-absorbing element 1 is supposed to have when used. Further, respective arrows indicating the “X-axis direction”, the “Y-axis direction” and the “Z-axis direction” in the drawings are only for illustration and are without entities.

As shown in FIGS. 1 and 2, the sintered body 2 has: the first end surface S11 and the second end surface S12 facing away from each other in the X-axis direction, the first side surface S21 and the second side surface S22 facing away from each other in the Y-axis direction, and the first principal surface S31 and the second principal surface S32 facing away from each other in the Z-axis direction.

As shown in FIG. 1, the sintered body 2 includes: the functioning part 4 having the void; and the outer shell part 5 covering the functioning part 4. The outer shell part 5 has a lower void ratio than the functioning part 4. Moreover, a main component of the functioning part 4 is different from a main component of the outer shell part 5.

The main component of the outer shell part 5 includes, for example, glass ceramics. The outer shell part 5 includes an element having a smaller work function than the functioning part, which enables discharge at a low voltage and provides a high surge-absorbing effect. As the glass ceramics, for example, low-temperature firing ceramics including alumina particles and borosilicate glass may be used.

The void ratio of the outer shell part 5 is preferably lower than or equal to 20%. Note that the void ratio of the outer shell part 5 is obtained by calculating the proportion of an area occupied by the void in a polished cross section of the outer shell part 5.

In the sintered body 2, the functioning part 4 is disposed in a region between the first internal electrode 31 and the second internal electrode 32 disposed to face each other in the Z-axis direction.

The functioning part 4 includes a porous body whose voltage dependency of a resistance value shows nonlinearity. The porous body included in the functioning part 4 has a gas cavity which is communicated with the first internal electrode 31 and the second internal electrode 32. A relationship between the value of a voltage applied to the functioning part 4 and the value of a current flowing through the porous body shows nonlinearity. Specifically, when the voltage applied to the functioning part 4 is lower than a predetermined voltage value, no current flows, and when a surge voltage higher than or equal to the predetermined voltage value is applied to the functioning part 4, creeping discharge along the gas cavity of the porous body occurs, thereby causing the surge current to flow. This enables the functioning part 4 to absorb the surge current.

The void ratio of the functioning part 4 is preferably greater than or equal to 25% and less than or equal to 92% and is, for example, 85%. Note that the void ratio of the functioning part 4 is obtained by calculating the proportion of an area occupied by the void in a polished cross section of the functioning part 4.

A main component of the porous body included in the functioning part 4 includes, for example, ZnO. Moreover, the functioning part 4 contains, as auxiliary components, for example, elements such as Sr, Ca, Co, Cr, Mn, and Al. The functioning part 4 includes crystal particles including ZnO as the main component and crystal grain boundaries including at least some of the auxiliary components. The thickness of the functioning part 4 in the Z-axis direction is, for example, 6 μm.

The first external electrode 41 and the second external electrode 42 are disposed on surfaces of the sintered body 2. Specifically, the first external electrode 41 is disposed to cover the entirety of the first end surface S11, a left end of the first side surface S21, a left end of the second side surface S22, a left end of the first principal surface S31, and a left end of the second principal surface S32 which are adjacent to the first end surface S11. Moreover, the second external electrode 42 is disposed to cover the entirety of the second end surface S12, a right end of the first side surface S21, a right end of the second side surface S22, a right end of the first principal surface S31, and a right end of the second principal surface S32 which are adjacent to the second end surface S12.

On condition that the first external electrode 41 and the second external electrode 42 of the present embodiment have the same shape and the same material constitution, only the first external electrode 41 will be described below, and the description of the second external electrode 42 will accordingly be omitted. Note that the first external electrode 41 and the second external electrode 42 are not limited to having the same shape and having the same material constitution.

In the following description, a portion which is part of the first external electrode 41 and which covers the entirety of the first end surface S11 may be referred to as the first portion C1. Moreover, portions which are part of the first external electrode 41 and which cover the left end of the first side surface S21, the left end of the second side surface S22, the left end of the first principal surface S31, and the left end of the second principal surface S32 may each be referred to as the second portion C2.

The first external electrode 41 includes a primary external electrode 61 in contact with the surfaces of the sintered body 2 and a secondary external electrode 62 covering the primary external electrode 61. In the present embodiment, the secondary external electrode 62 covers the entirety of the primary external electrode 61. That is, the first portion C1 includes the primary external electrode 61 and the secondary external electrode 62, and each of the second portions C2 includes the primary external electrode 61 and the secondary external electrode 62.

The primary external electrode 61 includes conductive metal such as, for example, silver (Ag). Note that the conductive metal included in the primary external electrode 61 may include at least one of, for example, Cu, Ni, Pd, an Ag-Pd alloy, or Au. Moreover, a feature of the primary external electrode 61 is that the primary external electrode 61 includes no resin.

The primary external electrode 61 is formed from a paste of Ag powder applied to the left and right ends of the sintered body 2 and treated with heat.

The secondary external electrode 62 may include a resin, for example, an epoxy resin, an amino resin such as a urea resin, a resol or novolac phenolic resin, and a silicone-modified organic resin such as silicone epoxy. Specifically, the secondary external electrode 62 may include an epoxy resin and conductive metal such as Ag.

Moreover, the secondary external electrode 62 further includes, as an additive, low-melting-point metal having a lower melting point than the conductive metal such as Ag. Examples of the low-melting-point metal include metals such as Sn, In, and Pb having a melting point of lower than or equal to 400° C.

The secondary external electrode 62 is formed from a paste obtained by mixing an epoxy resin in fluid form before curing, powder of the conductive metal, and powder of the low-melting-point metal together, applied to the primary external electrode 61, and treated with heat.

Since the secondary external electrode 62 includes the resin, the secondary external electrode 62 has a smaller elastic modulus than the primary external electrode 61 and thus has improved resistance to deformation. Moreover, since the secondary external electrode 62 includes the conductive metal, the secondary external electrode 62 is electrically connected to the primary external electrode 61.

The volume content of the resin in the secondary external electrode 62 is preferably higher than or equal to 30% and lower than or equal to 60%.

Moreover, the thermal conductivity of the secondary external electrode 62 is lower than the thermal conductivity of the primary external electrode 61.

Here, as shown in FIGS. 1 to 3, a thickness t22 of the secondary external electrode 62 at each of the second portions C2 is smaller than a thickness t12 of the secondary external electrode 62 at the first portion C1. As an example, the thickness t22 is about 50 μm, and the thickness t12 is about 100 μm.

Moreover, a thickness t21 of the primary external electrode 61 at each of the second portion C2 is smaller than a thickness t11 of the primary external electrode 61 at the first portion C1. As an example, the thickness t21 is about 20 μm, and the thickness t11 is about 80 μm. Note that the thickness t21 may be substantially equal to the thickness t11.

Thus, a thickness t2 of each of the second portions C2 is smaller than a thickness t1 of the first portion C1.

These configurations enable heat generated when a surge current flows through the functioning part 4 to efficiency be dissipated via the second portions C2 into the substrate as compared with the case of connection via the first portion C1 to the substrate. Note that a mounting surface mounted on a mounting part of the substrate is one surface of the first side surface S21, the second side surface S22, the first principal surface S31, and the second principal surface S32 and is, for example, the second principal surface S32.

Moreover, since the thickness t22 of the secondary external electrode 62 at each of the second portions C2 is smaller than the thickness t21 of the primary external electrode 61 at each of the second portions C2, the heat dissipation effect via the second portions C2 can be further enhanced.

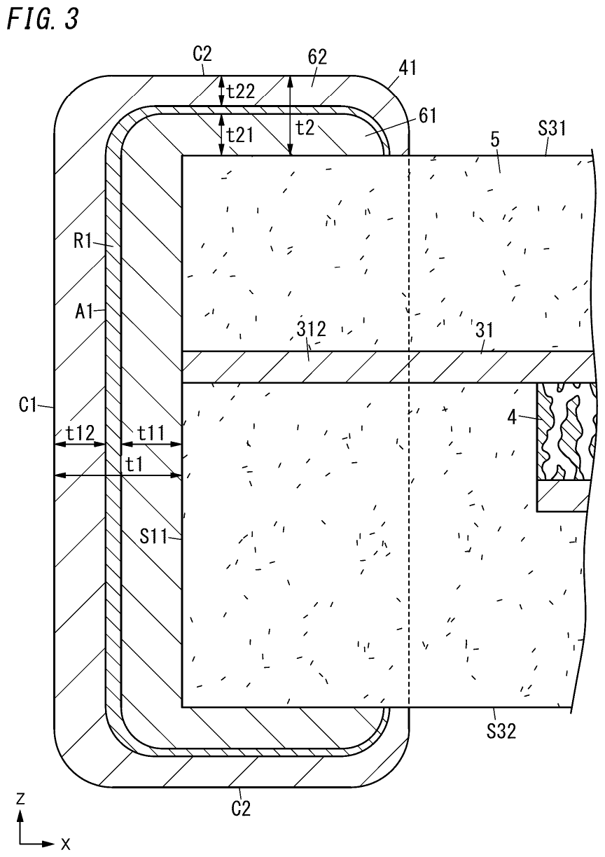

As shown in FIG. 3, the first external electrode 41 further has a reaction area A1 between the primary external electrode 61 and the secondary external electrode 62. The reaction area A1 includes a reactant R1 of the primary external electrode 61 and the secondary external electrode 62.

The reactant R1 includes, for example, a metal component having a melting point of lower than or equal to 400° C. Specifically, the reactant R1 is an alloy of the conductive metal such as Ag included in the primary external electrode 61 and the low-melting-point metal such as Sn, In, or Pb included in the secondary external electrode 62 and having a melting point of lower than or equal to 400° C.

The alloy of the conductive metal and the low-melting-point metal is produced by diffusing the low-melting-point metal of the secondary external electrode 62 into the conductive metal of the primary external electrode 61 at the time of formation of the secondary external electrode 62 by heat treatment. In this case, the reaction area A1 is an area in which an alloy which is the reactant R1 has been diffused into the conductive metal. Thus, an anchor effect by the alloy diffused into the conductive metal reduces the chances that the secondary external electrode 62 peels off from the primary external electrode 61.

Note that the secondary external electrode 62 may include, as an additive, a substance including, for example, a glass component. The glass component may include, specifically, for example, B, Si, Zn, Ba, Mg, Al, or Li. In this case, at the time of formation of the secondary external electrode 62 by heat treatment, diffusion of the glass component of the secondary external electrode 62 into the conductive metal of the primary external electrode 61 produces a reactant R1 including the glass component.

The reactant R1 can be confirmed by using an energy dispersive X-ray spectroscope (EDS) or through an element analysis by using an electron beam micro analyzer (EPMA).

As shown in FIGS. 1 and 2, the first internal electrode 31 and the second internal electrode 32 are disposed in the sintered body 2.

The first internal electrode 31 and the second internal electrode 32 face each other in the Z-axis direction while the functioning part 4 is disposed therebetween as described above.

The first internal electrode 31 and the second internal electrode 32 include, for example, an Ag-Pd alloy. Note that the first internal electrode 31 and the second internal electrode 32 may include at least one of, for example, Pd, Au, Ag, or Pt.

Each of the first internal electrode 31 and the second internal electrode 32 has a rectangular shape while its longitudinal direction is in the X-axis direction and its transverse direction is in the Y-axis direction.

As shown in FIG. 1, the first internal electrode 31 includes a first counter part 311 and a first lead-out part 312. Moreover, the second internal electrode 32 includes a second counter part 321 and a second lead-out part 322.

The first counter part 311 and the second counter part 321 face each other in the Z-axis direction while the functioning part 4 is disposed therebetween. In other words, of the first internal electrode 31, a part in contact with the functioning part 4 is the first counter part 311, and of the second internal electrode 32, a part in contact with the functioning part 4 is the second counter part 321.

The first lead-out part 312 protrudes from the first counter part 311 leftward in the X-axis direction. On the first end surface S11 of the sintered body 2, a left end of the first lead-out part 312 is electrically connected to the first external electrode 41.

The second lead-out part 322 protrudes from the second counter part 321 rightward in the X-axis direction. On the second end surface S12 of the sintered body 2, a right end of the second lead-out part 322 is electrically connected to the second external electrode 42.

### (3) Variations

Variations of the surge-absorbing element 1 of the present disclosure will be described below. Note that components similar to those in the embodiment described above are denoted by the same reference signs as those in the embodiment, and the description thereof is accordingly omitted. Moreover, any of the variations to be described below may be combined as appropriate with the embodiment described above. On condition that the first external electrode 41 and the second external electrode 42 of the variations to be described below have the same shape and the same material constitution, only the first external electrode 41 will be described below, and the description of the second external electrode 42 will accordingly be omitted. Note that the first external electrode 41 and the second external electrode 42 are not limited to having the same shape and having the same material constitution.

### (3.1) First Variation

In the embodiment described above, the length of the second portion C2 from the first end surface S11 along the X-axis direction on each of the first side surface S21 and the second side surface S22 is substantially constant in the Z-axis direction as shown in FIGS. 1 and 2. Moreover, the length of the second portion C2 from the end surface S11 along the X-axis direction on each of the first principal surface S31 and the second principal surface S32 is substantially constant in the Y-axis direction.

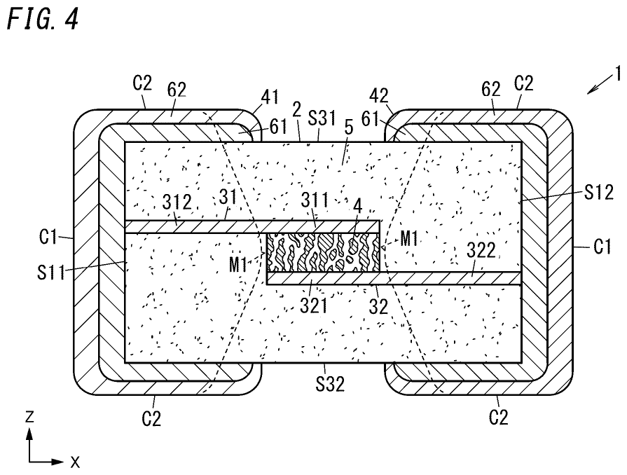

In a first variation, the length of the second portion C2 from the first end surface S11 along the X-axis direction on each of the first side surface S21 and the second side surface S22 is, unlike the embodiment described above, greater at a center part M1 in the Z-axis direction apart from edges in the Z-axis direction than at each of the edges as shown in FIG. 4. Note that the edges in the Z-axis direction on the first side surface S21 are a border between the first side surface S21 and the first principal surface S31 adjacent to each other and a border between the first side surface S21 and the second principal surface S32 adjacent to each other. Similarly, the edges in the Z-axis direction on the second side surface S22 are a border between the second side surface S22 and the first principal surface S31 adjacent to each other and a border between the second side surface S22 and the second principal surface S32 adjacent to each other.

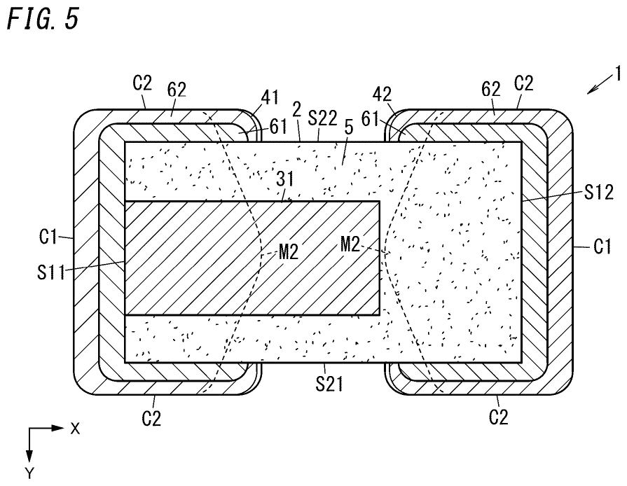

Moreover, the length of the second portion C2 from the first end surface S11 along the X-axis direction on each of the first principal surface S31 and the second principal surface S32 is greater at a center part M2 in the Y-axis direction apart from edges in the Y-axis direction than at each of the edges as shown in FIG. 5. Note that the edges in the Y-axis direction on the first principal surface S31 are a border between the first principal surface S31 and the first side surface S21 adjacent to each other and a border between the first principal surface S31 and the second side surface S22 adjacent to each other. Similarly, the edges in the Y-axis direction on the second principal surface S32 are a border between the second principal surface S32 and the first side surface S21 adjacent to each other and a border between the second principal surface S32 and the second side surface S22 adjacent to each other.

Thus, the center part M1 and the center part M2 of the second portions C2 cover vicinities of the functioning part 4 respectively on each of the first side surface S21 and the second side surface S22 and on each of the first principal surface S31 and the second principal surface S32, thereby more efficiently dissipating heat generated from the functioning part 4 into the substrate via the second portions C2.

Moreover, since the center part M1 of the second portion C2 covers the vicinity of the functioning part 4 on each of the first side surface S21 and the second side surface S22, resistance to stress in the Z-axis direction which may form a crack in the surge-absorbing element 1 can be improved. Moreover, since the center part M2 of the second portion C2 covers the vicinity of the functioning part 4 on each of the first principal surface S31 and the second principal surface S32, resistance to stress in the Y-axis direction which may form a crack in the surge-absorbing element 1 can be improved.

### (3.2) Second Variation

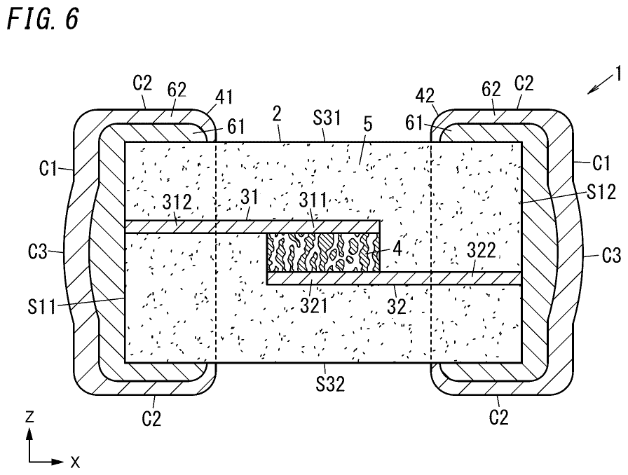

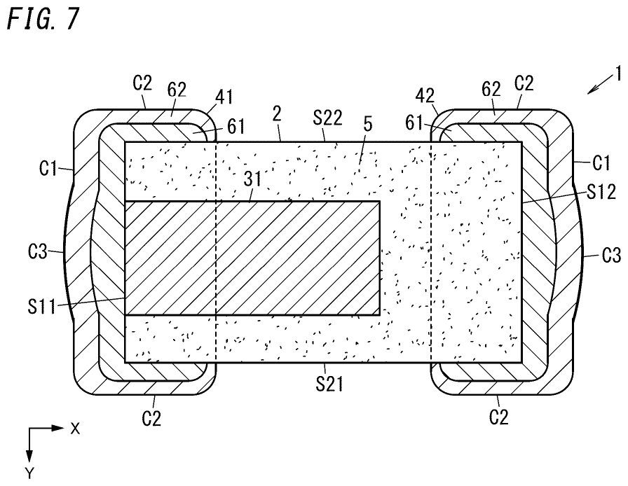

In a second variation, the thickness of the first portion C1 covering the first end surface S11 is greater at a connection portion C3 connected to the first internal electrode 31 than at portions except for the connection portion C3 as shown in FIGS. 6 and 7. The connection portion C3 can have higher resistance than the portions except for the connection portion C3, and thermal shock when a current flows can be greater at the connection portion C3 than at the portions except for the connection portion C3. Therefore, increasing the thickness of the connection portion C3 as described above can improve the resistance of the connection portion C3 to the thermal shock.

### (3.3) Third Variation

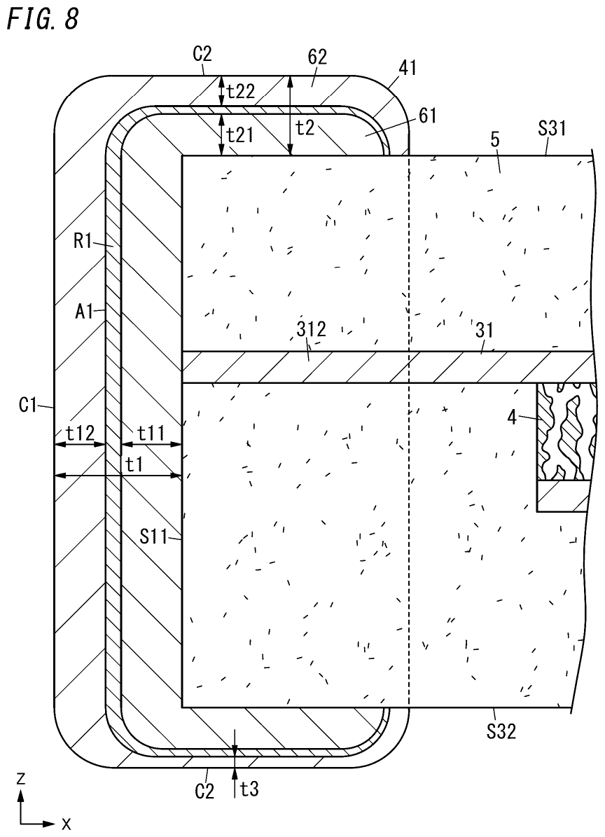

In a third variation, a thickness t3 of a portion, covering, for example, the second principal surface S32 which is a mounting surface, of the secondary external electrode 62 is smaller than the thickness (t12, t22) of each of portions, covering surfaces except for the second principal surface S32, of the secondary external electrode 62 as shown in FIG. 8. Thus, while heat is efficiently dissipated from the second principal surface S32 into the substrate, the resistance to the thermal shock on the surfaces, except for the second principal surface S32, of the surge-absorbing element 1 can be secured.

### (3.4) Fourth Variation

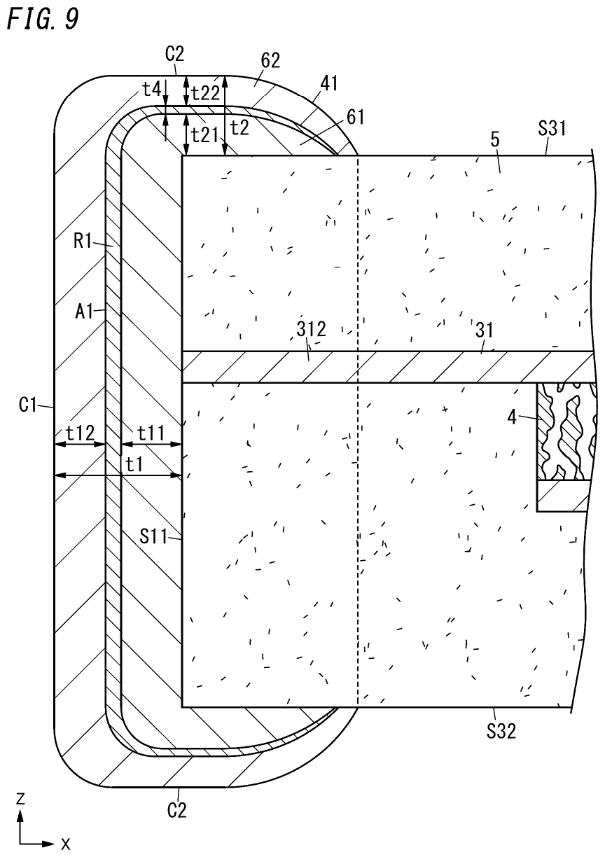

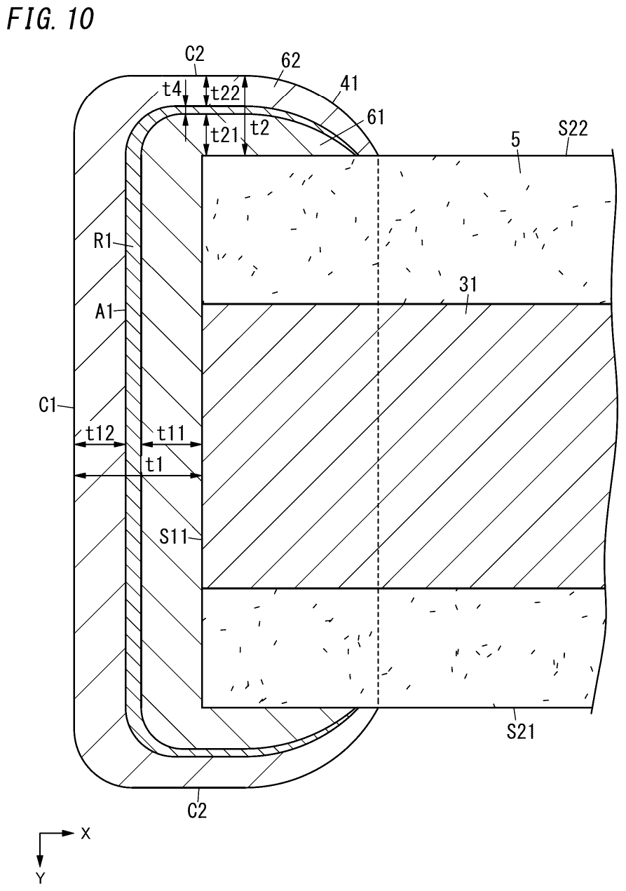

In a fourth variation, the thickness of the reaction area A1 at each of the second portions C2 covering each of the first side surface S21, the second side surface S22, the first principal surface S31, and the second principal surface S32 decreases as the distance from the first end surface S11 increases as shown in FIGS. 9 and 10. In other words, the thickness of the reaction area A1 at each of the second portions C2 covering each of the first side surface S21, the second side surface S22, the first principal surface S31, and the second principal surface S32 decreases as the distance to the functioning part 4 decreases in the X-axis direction.

Moreover, the thickness t2 of each of the second portions C2 covering each of the first side surface S21, the second side surface S22, the first principal surface S31, and the second principal surface S32 also decreases as the distance from the first end surface S11 increases. In other words, the thickness t2 of each of the second portions C2 covering each of the first side surface S21, the second side surface S22, the first principal surface S31, and the second principal surface S32 decreases, as the distance to the functioning part 4 decreases in the X-axis direction.

Thus, the resistance to the thermal shock can be secured at portions, close to the first end surface S11, of the second portions C2, while dissipation of heat into the substrate can be improved at portions, close to the functioning part 4, of the second portions C2.

### (3.5) Fifth Variation

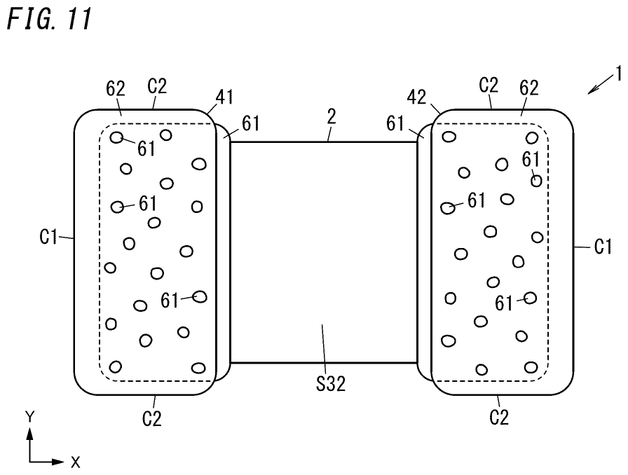

In a fifth variation, the primary external electrode 61 is partially exposed from the secondary external electrode 62 at each of the second portions C2. For example, as shown in FIG. 11, part of the primary external electrode 61 is exposed in spots from the secondary external electrode 62 at the second portion C2 covering the second principal surface S32, which is the mounting surface. The part of the primary external electrode 61 exposed in spots extends through, for example, the secondary external electrode 62 in a thickness direction. Moreover, the part of the primary external electrode 61 is exposed, at the second portion C2 covering the second principal surface S32, from a right end of the secondary external electrode 62 along the X-axis direction.

Thus, when the surge-absorbing element 1 is mounted on the substrate, the primary external electrode 61 exposed from the secondary external electrode 62 and the substrate come into contact with each other at the second principal surface S32, and therefore, heat generated at the functioning part 4 can efficiently be dissipated into the substrate via the primary external electrode 61 having higher thermal conductivity than the secondary external electrode 62.

### (3.6) Sixth Variation

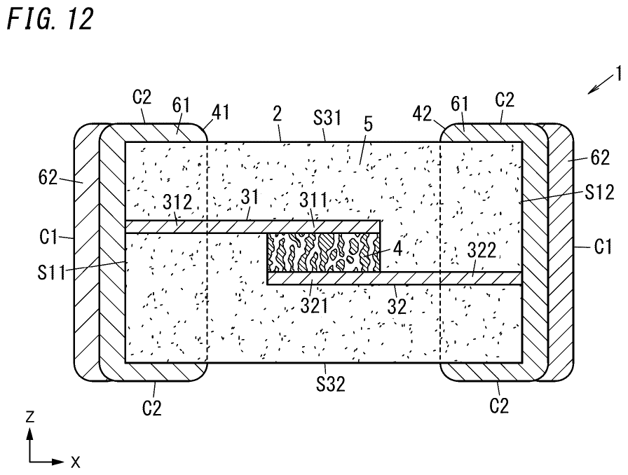

In a sixth variation, the secondary external electrode 62 is disposed to cover the primary external electrode 61 at the first portion C1 as shown in FIG. 12. In other words, in the sixth variation, the second portions C2 of the first external electrode 41 and the second external electrode 42 include no secondary external electrode 62 and consist of the primary external electrode 61.

Thus, when the surge-absorbing element 1 is mounted on the substrate, the primary external electrode 61 and the substrate come into contact with each other at the entirety of the second principal surface S32, which is the mounting surface, and therefore, heat generated at the functioning part 4 can efficiently be dissipated into the substrate via the primary external electrode 61 having higher thermal conductivity than the secondary external electrode 62.

### (4) Summary

As described above, a surge-absorbing element (1) of a first aspect includes a sintered body (2), a pair of internal electrodes (31, 32), and a pair of external electrodes (41, 42). The sintered body (2) has a pair of end surfaces (S11, S12) facing away from each other and a plurality of side surfaces (S21, S22, S31, S32) each adjacent to the pair of end surfaces (S11, S12). The pair of internal electrodes (31, 32) are disposed in the sintered body (2). The pair of external electrodes (41, 42) are disposed on the pair of end surfaces (S11, S12) on a one-to-one basis and are electrically connected to the pair of internal electrodes (31, 32) on a one-to-one basis. The sintered body (2) includes a functioning part (4) having a void and an outer shell part (5) covering the functioning part (4) and having a lower void ratio than the functioning part (4). The pair of internal electrodes (31, 32) face each other while the functioning part (4) is disposed between the pair of internal electrodes (31, 32). Each of the pair of external electrodes (41, 42) includes a first portion (C1) covering a corresponding one of the pair of end surfaces (S11, S12) and second portions (C2) each covering at least part of a corresponding one of the plurality of side surfaces (S21, S22, S31, S32). A thickness of each of the second portions (C2) is smaller than a thickness of the first portion (C1).

With this aspect, mounting the surge-absorbing element (1) on a substrate such that the second portion (C2) of each of the pair of external electrodes (41, 42) is in contact with the substrate enables heat generated when a surge current flows through the functioning part (4) to efficiently be dissipated into the substrate via the second portions (C2) each having a smaller thickness than the first portion (C1).

In a surge-absorbing element (1) of a second aspect referring to the first aspect, the functioning part (4) includes a porous body. Voltage dependency of a resistance value of the porous body shows nonlinearity.

With this aspect, when a surge voltage higher than or equal to a predetermined voltage value is applied to the functioning part (4), a surge current flows, and the functioning part (4) can absorb the surge current.

In a surge-absorbing element (1) of a third aspect referring to the first or second aspect, the second portions (C2) each have a length from the corresponding one of the pair of end surfaces, the length of each of the second portions (C2) from the corresponding one of the pair of end surfaces being greater at a center part (M1, M2) apart from a border between adjacent two side surfaces of the plurality of side surfaces (S21, S22, S31, S32) than at the border.

With this aspect, the center part (M1, M2) of each of the second portions (C2) covers the vicinity of the functioning part (4), thereby more efficiently dissipating heat generated from the functioning part (4) into the substrate via the second portions (C2).

In a surge-absorbing element (1) of a fourth aspect referring to any one of the first to third aspects, the first portion (C1) has a connection portion (C3) connected to one of the pair of internal electrodes (31, 32), a thickness of the connection portion (C3) being greater than parts of the first portion (C1) except for the connection portion (C3).

This aspect enables the resistance of the connection portion (C3) to thermal shock to be improved.

A surge-absorbing element (1) of a fifth aspect includes a sintered body (2), a pair of internal electrodes (31, 32), and a pair of external electrodes (41, 42). The sintered body (2) has a pair of end surfaces (S11, S12) facing away from each other and a plurality of side surfaces (S21, S22, S31, S32) each adjacent to the pair of end surfaces (S11, S12). The pair of internal electrodes (31, 32) are disposed in the sintered body (2). The pair of external electrodes (41, 42) are disposed on the pair of end surfaces (S11, S12) on a one-to-one basis and are electrically connected to the pair of internal electrodes (31, 32) on a one-to-one basis. The sintered body (2) includes a functioning part (4) having a void and an outer shell part (5) covering the functioning part (4) and having a lower void ratio than the functioning part (4). The pair of internal electrodes (31, 32) face each other while the functioning part (4) is disposed between the pair of internal electrodes (31, 32). Each of the pair of external electrodes (41, 42) includes a first portion (C1) covering a corresponding one of the pair of end surfaces (S11, S12) and second portions (C2) each covering at least a corresponding one of the plurality of side surfaces (S21, S22, S31, S32). The second portions (C2) each have a length from the corresponding one of the pair of end surfaces, the length of each of the second portions (C2) from the corresponding one of the pair of end surfaces being greater at a center part (M1, M2) apart from a border between adjacent two side surfaces of the plurality of side surfaces (S21, S22, S31, S32) than at the border.

With this aspect, the center part (M1, M2) of each of the second portions (C2) covers the vicinity of the functioning part (4), thereby more efficiently dissipating heat generated from the functioning part (4) into the substrate via the second portions (C2).

In a surge-absorbing element (1) of a sixth aspect referring to any one of the first to fifth aspects, each of the pair of external electrodes (41, 42) includes a primary external electrode (61) in contact with a surface of the sintered body (2) and a secondary external electrode (62) covering the primary external electrode (61).

This aspect enables the resistance of the pair of external electrodes (41, 42) to thermal shock to be improved.

In a surge-absorbing element (1) of a seventh aspect referring to the sixth aspect, a thickness (t22) of the secondary external electrode (62) at each of the second portions (C2) is smaller than a thickness (t12) of the secondary external electrode (62) at the first portion (C1).

This aspect enables the thickness of each of the second portions (C2) to be smaller than the thickness of the first portion (C1) and enables heat generated when a surge current flows through the functioning part (4) to efficiently be dissipated into the substrate via the second portions (C2) each having a smaller thickness than the first portion (C1).

In a surge-absorbing element (1) of an eighth aspect referring to the sixth or seventh aspect, at each of the second portions (C2), a thickness of the secondary external electrode (62) is smaller than a thickness of the primary external electrode (61).

This aspect enables each of the second portions (C2) to further be thinned and enables heat generated when a surge current flows through the functioning part (4) to efficiently be dissipated into the substrate via the second portions (C2).

In a surge-absorbing element (1) of a ninth aspect referring to any one of the sixth to eighth aspects, the plurality of side surfaces (S21, S22, S31, S32) include a mounting surface which is to be mounted on a mounting part. The secondary external electrode (62) includes a portion at least partially covering the mounting surface, the secondary external electrode (62) includes a portion covering the plurality of side surfaces except for the mounting surface, and the portion at least partially covering the mounting surface has a thickness smaller than a thickness of the portion covering the plurality of side surfaces except for the mounting surface.

This aspect enables the resistance of the side surfaces except for the mounting surface to the thermal shock to be improved while heat generated when a surge current flows through the functioning part (4) is efficiently dissipated through the mounting surface into the substrate.

In a surge-absorbing element (1) of a tenth aspect referring to any one of the sixth to ninth aspects, each of the pair of external electrodes (41, 42) further has a reaction area (A1) between the primary external electrode (61) and the secondary external electrode (62). The reaction area (A1) includes a reactant (R1) of the primary external electrode (61) and the secondary external electrode (62).

This aspect reduces the chances that the secondary external electrode (62) peels off from the primary external electrode (61).

In a surge-absorbing element (1) of an eleventh aspect referring to the tenth aspect, at each of the second portions (C2), a thickness of the reaction area (A1) decreases as a distance from the corresponding one of the pair of end surfaces increases.

This aspect enables the resistance to the thermal shock to be enhanced at a portion, close to the end surface (S11, S12), of each of the second portions (C2) and enables the effect of heat dissipation into the substrate to be enhanced at a portion, close to the functioning part (4), of each of the second portions (C2).

In a surge-absorbing element (1) of a twelfth aspect referring to the tenth or eleventh aspect, the reactant (R1) includes a metal component having a melting point of lower than or equal to 400° C.

This aspect reduces the chances that the secondary external electrode (62) peels off from the primary external electrode (61).

In a surge-absorbing element (1) of a thirteenth aspect referring to any one of the tenth to twelfth aspects, the reactant (R1) includes a glass component.

This aspect reduces the chances that the secondary external electrode (62) peels off from the primary external electrode (61).

In a surge-absorbing element (1) of a fourteenth aspect referring to any one of the sixth to thirteenth aspects, at each of the second portions (C2), at least part of the primary external electrode (61) is exposed from the secondary external electrode (62).

with this aspect, the primary external electrode (61) exposed through the secondary external electrode (62) and the substrate are brought into contact with each other, thereby efficiently dissipating heat generated at the functioning part (4) via the primary external electrode (61).

In a surge-absorbing element (1) according to a fifteenth aspect referring to any one of the sixth to fourteenth aspects, the secondary external electrode (62) is disposed to cover the primary external electrode (61) at the first portion (C1).

This aspect enables heat generated at the functioning part (4) to efficiently be dissipated into the substrate via each of the second portions (C2) not covered with the secondary external electrode (62) into the substrate while the resistance of the first portion (C1) to the thermal shock is improved.

In a surge-absorbing element (1) of a sixteenth aspect referring to any one of the sixth to fifteenth aspects, thermal conductivity of the secondary external electrode (62) is lower than thermal conductivity of the primary external electrode (61).

This aspect suppresses a temperature of the secondary external electrode (62) from rising.

In a surge-absorbing element (1) of a seventeenth aspect referring to any one of sixth to sixteenth aspects, the primary external electrode (61) includes no resin, and the secondary external electrode (62) includes a resin.

This aspect enables the resistance of the secondary external electrode (62) to deformation to be improved as compared with the primary external electrode (61).

In a surge-absorbing element (1) according to an eighteenth aspect referring to any one of the first to seventeenth aspects, a main component of the functioning part (4) is different from a main component of the outer shell part (5).

This aspect enables the functioning part (4) to have a different resistance characteristic from the outer shell part (5).

In a surge-absorbing element (1) of a nineteenth aspect referring to any one of the first to eighteenth aspects, a main component of the functioning part (4) includes ZnO, and a main component of the outer shell part (5) includes glass ceramics.

This aspect enables the functioning part (4) to have a different resistance characteristic from the outer shell part (5).

Note that the second to fourth aspects and the sixth to nineteenth aspects are not configurations essential for the surge-absorbing element (1) of the first aspect and may thus accordingly be omitted. Moreover, the sixth to nineteenth aspects are not configurations essential for the surge-absorbing element (1) of the fifth aspect and may thus accordingly be omitted.

### REFERENCE SIGNS LIST

1 Surge-Absorbing Element
2 Sintered Body
4 Functioning Part
5 Outer Shell Part
31, 32 Internal Electrode
41, 42 External Electrode
61 Primary External Electrode
62 Secondary External Electrode
A1 Reaction Area
C1 First Portion
C2 Second Portion
C3 Connection Portion
M1, M2 Center Part
R1 Reactant
S11, S12 End Surface
S21, S22, S31, S32 Side Surface
T12 Thickness
T22 Thickness

1. A surge-absorbing element comprising:
a sintered body having
a pair of end surfaces facing away from each other and
a plurality of side surfaces each adjacent to the pair of end surfaces;
a pair of internal electrodes disposed in the sintered body; and
a pair of external electrodes disposed on the pair of end surfaces on a one-to-one basis and electrically connected to the pair of internal electrodes on a one-to-one basis,
the sintered body including
a functioning part having a void and
an outer shell part covering the functioning part and having a lower void ratio than the functioning part,
the pair of internal electrodes facing each other while the functioning part is disposed between the pair of internal electrodes,
each of the pair of external electrodes including
a first portion covering a corresponding one of the pair of end surfaces and
second portions each covering at least part of a corresponding one of the plurality of side surfaces,
a thickness of each of the second portions being smaller than a thickness of the first portion.

2. The surge-absorbing element of claim 1, wherein
the functioning part includes a porous body, and
voltage dependency of a resistance value of the porous body shows nonlinearity.

3. The surge-absorbing element of claim 1, wherein
the second portions each have a length from the corresponding one of the pair of end surfaces, the length of each of the second portions from the corresponding one of the pair of end surfaces being greater at a center part apart from a border between adjacent two side surfaces of the plurality of side surfaces than at the border.

4. The surge-absorbing element of claim 1, wherein
the first portion has a connection portion connected to one of the pair of internal electrodes, and a thickness of the connection portion being greater than parts of the first portion except for the connection portion.

5. A surge-absorbing element comprising:
a sintered body having
a pair of end surfaces facing away from each other and
a plurality of side surfaces each adjacent to the pair of end surfaces;
a pair of internal electrodes disposed in the sintered body; and
a pair of external electrodes disposed on the pair of end surfaces on a one-to-one basis and electrically connected to the pair of internal electrodes on a one-to-one basis,
the sintered body including
a functioning part having a void and
an outer shell part covering the functioning part and having a lower void ratio than the functioning part,
the pair of internal electrodes facing each other while the functioning part is disposed between the pair of internal electrodes,
each of the pair of external electrodes including
a first portion covering a corresponding one of the pair of end surfaces and
second portions each covering at least part of a corresponding one of the plurality of side surfaces,
the second portions each having a length from the corresponding one of the pair of end surfaces, the length of each of the second portions from the corresponding one of the pair of end surfaces being greater at a center part apart from a border between adjacent two side surfaces of the plurality of side surfaces than at the border.

6. The surge-absorbing element of claim 1, wherein
each of the pair of external electrodes includes
a primary external electrode in contact with a surface of the sintered body and
a secondary external electrode covering the primary external electrode.

7. A surge-absorbing element of claim 6, wherein
a thickness of the secondary external electrode at each of the second portions is smaller than a thickness of the secondary external electrode at the first portion.

8. The surge-absorbing element of claim 6, wherein
at each of the second portions, a thickness of the secondary external electrode is smaller than a thickness of the primary external electrode.

9. The surge-absorbing element of claim 6, wherein
the plurality of side surfaces includes a mounting surface which is to be mounted on a mounting part,
the secondary external electrode includes a portion at least partially covering the mounting surface,
the secondary external electrode includes a portion covering the plurality of side surfaces except for the mounting surface, and
the portion at least partially covering the mounting surface has a thickness smaller than a thickness of the portion covering the plurality of side surfaces except for the mounting surface.

10. The surge-absorbing element of claim 6, wherein
each of the pair of external electrodes further has a reaction area between the primary external electrode and the secondary external electrode, and
the reaction area includes a reactant of the primary external electrode and the secondary external electrode.

11. The surge-absorbing element of claim 10, wherein
at each of the second portions, a thickness of the reaction area decreases as a distance from the corresponding one of the pair of end surfaces increases.

12. The surge-absorbing element of claim 10, wherein
the reactant includes a metal component having a melting point of lower than or equal to 400° C.

13. The surge-absorbing element of claim 10, wherein
the reactant includes a glass component.

14. The surge-absorbing element of claim 6, wherein
at each of the second portions, at least part of the primary external electrode is exposed from the secondary external electrode.

15. The surge-absorbing element of claim 6, wherein
the secondary external electrode is disposed to cover the primary external electrode at the first portion.

16. The surge-absorbing element of claim 6, wherein
thermal conductivity of the secondary external electrode is lower than thermal conductivity of the primary external electrode.

17. The surge-absorbing element of claim 6, wherein
the primary external electrode includes no resin, and
the secondary external electrode includes a resin.

18. The surge-absorbing element of claim 1, wherein
a main component of the functioning part is different from a main component of the outer shell part.

19. The surge-absorbing element of claim 1, wherein
a main component of the functioning part includes ZnO, and
a main component of the outer shell part includes glass ceramics.

20. The surge-absorbing element of claim 2, wherein
the second portions each have a length from the corresponding one of the pair of end surfaces, the length of each of the second portions from the corresponding one of the pair of end surfaces being greater at a center part apart from a border between adjacent two side surfaces of the plurality of side surfaces than at the border.
